(19) United States
(12) Patent Application Publication
(10) Pub. No.: US 2010/0065398 A1
(43) Pub. Date: Mar. 18, 2010

(54) ELECTROMAGNETICALLY OPERATED CLUTCH AND METHOD OF OPERATING AN ELECTROMAGNETICALLY OPERATED CLUTCH

(75) Inventors: Rainer KRAFFT, Heiligenberg (DE); Johannes Ganahl, Markdorf (DE)

Correspondence Address: BURR & BROWN, PO BOX 7068, SYRACUSE, NY, 13261-7068, US

(73) Assignee: Licos Trucktec GmbH, Markdorf (DE)

(21) Appl. No.: 12/561,325

(22) Filed: Sep. 17, 2009

(30) Foreign Application Priority Data
Sep. 18, 2008 (DE) 10 2008 047 983.7

(51) Int. Cl. F16D 27/14

(52) U.S. Cl. 192/84.1

(57) ABSTRACT

An electromagnetically operated clutch, in particular a friction clutch, for switching on and off units, such as a water pump, in a vehicle, having a predefined electrical system voltage, the clutch including an electromagnet with at least one coil, a rotor, an armature plate, which is attracted to the rotor by the forces of the electromagnet in order to engage the clutch, and control means. The control means, which, in respect of a continuous operating state, are designed for an operating voltage level, which is less than the available electrical system voltage of the vehicle, the control means being suited to switching the electromagnet with a voltage level for engagement of the friction clutch that is greater than operating voltage level and, by timing the supply voltage, to reducing it to the design operating voltage level for an operating phase when the clutch is continuously engaged.

This application claims the benefit under 35 USC §119(a)-(d) of German Application No. 10 2008 047 983.7 filed Sep. 18, 2008, the entirety of which is incorporated herein by reference.

### FIELD OF THE INVENTION

The invention relates to an electromagnetically operated clutch and a method of operating an electromagnetically operated clutch.

### BACKGROUND OF THE INVENTION

Friction clutches are commonly arranged between a vehicle engine and a driven unit so as to be able to switch the unit on and off.

In this case the electromagnet of a conventional clutch is usually designed for the available electrical system voltage of the vehicle.

DE 10 309 548 A1 shows an electromagnetically operated friction clutch and a method of operating an electromagnetically operated friction clutch, especially for switching on and off units in vehicles, which comprises at least one coil, a rotor, an armature plate, which can be drawn against the rotor by the magnetic force of the electromagnet in order to engage the clutch, and control means. The control means and the electromagnet are designed to interact in order to give an at least temporary increase in the magnetic flux density generated by the electromagnet in the area of the armature plate compared to a mean magnetic flux density for an operating phase when the clutch is continuously engaged.

In order to increase the flux density, in the aforementioned publication the electromagnet is briefly subjected in the energizing phase to a voltage in excess of the available electrical system voltage of the vehicle.

The magnetic force is thereby increased in such a way that the armature plate is drawn against the rotor within a very brief time.

If the clutch is engaged, the supply voltage of the electromagnet is reduced to the available electrical system voltage of the vehicle.

This transient voltage increase entails additional circuitry costs for the additional means capable of increasing the voltage.

### SUMMARY OF THE INVENTION

The object of the invention is to provide an electromagnetically operated friction clutch, which can be efficiently operated at comparatively low cost.

The invention initially proceeds from an electromagnetically operated clutch, in particular a friction clutch, for switching on and off units, such as a water pump, for example, in a vehicle, in particular a motor vehicle, having an available electrical system voltage, the clutch comprising an electromagnet with at least one coil, a rotor, an armature plate, which is drawn against the rotor by the forces of the electromagnet in order to engage the clutch, and control means.

The essence of the invention resides in the fact that the control means in respect of a continuous operating state are designed for an operating voltage level, which is less than the available electrical system voltage of the vehicle, the control means being suited to switching the electromagnet with a voltage level for engagement of the friction clutch that is greater than the operating voltage level and, by timing a supply voltage, to reducing it to the design operating voltage level for an operating phase when the clutch is continuously engaged.

Timing serves for intermittently switching the electromagnet supply voltage on and off.

A mean operating voltage is established on the basis of a supply voltage for an electromagnet, it being possible to predefine different operating voltage levels with different timings.

According to the invention the supply voltage of the electromagnet may lie in the range between the available electrical system voltage of the vehicle and the desired operating voltage for a continuously engaged clutch. The clutch is designed for continuous operation at the desired operating voltage.

This approach allows the clutch, when it is being engaged, to be temporarily subjected to a supply voltage which exceeds the continuous operating voltage level and which may briefly be approximately equal to the electrical system voltage in the vehicle.

This allows the friction clutch to be engaged even when a wear gap has reached a magnitude for which the operating voltage level would no longer suffice for a continuous operating state.

For this purpose the engagement ranges of the supply voltage can simply be increased or the supply voltage is briefly applied untimed to the electromagnet.

A voltage level is thereby established, which exceeds the operating voltage level without having to provide a voltage which is higher than electrical system voltage.

An increase in the voltage level for the purpose of engagement generates magnetic forces which are capable, even within a brief time, of ensuring the engagement of an electromagnetically operated friction clutch having a comparatively high degree of wear.

It is furthermore possible to increase a maintenance interval of a friction clutch, since an increase in the voltage level for engagement at the energizing point forms sufficiently large magnetic forces for engagement of the clutch even in the event of a large wear gap.

In a preferred development of the invention the supply voltage of the electromagnet at the energizing point is equal to the available electrical system voltage of the vehicle.

In this simple case the electrical system voltage is simply applied to the actuating electronics.

In addition the electromagnet can generate a magnetic force in order to draw an armature plate against the rotor even over a comparatively large distance occurring due to wear, since the electrical system voltage will preferably be significantly in excess of the operating voltage level.

In an especially preferred development of the invention the supply voltage can be timed by means of pulse width modulation (PWM).

In this case the supply voltage can be designed for a desired operating voltage level by adjusting the pulse width of the pulse width modulation signal.

Where necessary, pulse width modulation can be performed by existing control means in a vehicle, obviating the need for additional circuitry expense.

With pulse width modulation the operating voltage level can be constantly adjusted to changing external conditions by a tried and tested control method.

Voltage fluctuations in the available electrical system voltage can thereby virtually be disregarded, since an immediate readjustment of the supply voltage can be performed by the pulse width modulation.

In a still further preferred development of the invention the control means reduces the voltage to an operating voltage level in the order of half the available electrical system voltage of the vehicle.

The electromagnet is preferably designed for a corresponding operating voltage level, and in particular also for continuous operation corresponding, for example, to approximately half the available electrical system voltage of the vehicle.

In a further, preferred development of the invention the control means reduces the voltage to an operating voltage level by means of a pulse width modulation signal having a predefined cycle duration.

In a still further preferred development of the invention the control means are suited to predefining a pulse width for a varying electrical system voltage, which is required for a continuous operating phase of the clutch.

Through readjustment of the pulse width it is possible to avoid a premature disengagement of the clutch due to any low voltage or voltage fluctuations in the available electrical system voltage of the vehicle.

In a further, preferred development of the invention the control means are embodied as a retrofitted unit.

A retrofitted unit allows existing electromagnetically operated friction clutches to be operated with timing according to the invention, for example by means of an adapter.

This is particularly advantageous when access to existing control means with pulse width modulation is possible for performing pulse width modulation.

The retrofitted control means ensure a reduction of the voltage level of the electromagnet for continuous operation.

It is furthermore feasible to replace a conventional electromagnet with an electromagnet designed for a reduced operating voltage level. This electromagnet can then be controlled with a pulse width modulation of an existing control means or a retrofitted control means.

The essence of the invention resides in the fact that the control means, by means of timing, reduce the supply voltage of an electromagnet to an operating voltage level for an operating phase of a continuously engaged clutch, which is less than the available electrical system voltage of the vehicle, the control means providing a supply voltage for engagement of the friction clutch that is greater than the operating voltage level.

Operating an electromagnet at a controlled operating voltage level allows the friction clutch according to the invention to be dimensioned smaller than a friction clutch that is operated only at an electrical system voltage, since the clutch does not need to continue functioning when the voltage is too low.

A clutch does not have to be over-dimensioned in order to ensure operation at voltages less than the voltage for continuous operation.

### BRIEF DESCRIPTION OF THE DRAWINGS

Further advantages and details are set forth in the drawings represented and will be explained in more detail below.

FIG. 1 shows a known voltage profile of an electromagnetically operated clutch with an operating voltage level at the electrical system voltage; and

FIG. 2 shows a voltage profile according to the invention of an electromagnetically operated clutch with pulse width modulation.

### DETAILED DESCRIPTION OF THE INVENTION

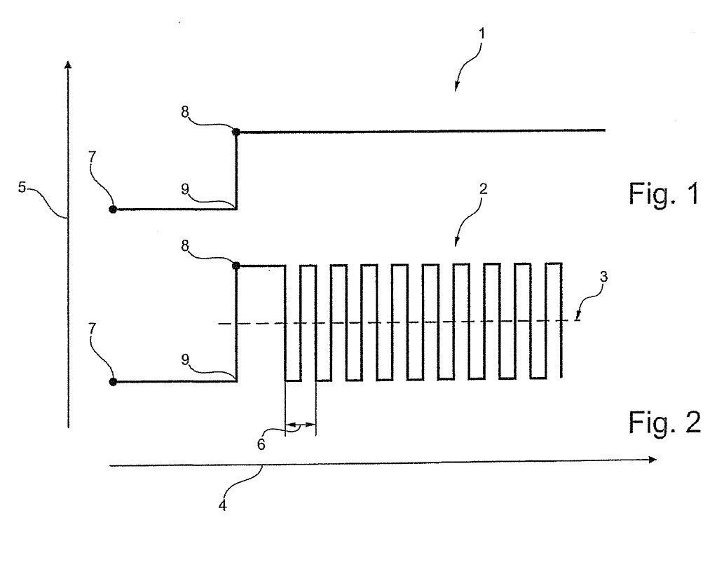

FIG. 1 shows a voltage profile 1 of an electromagnetically operated friction clutch, the voltage being represented on the voltage axis 5 and the voltage variation with time on a time axis 4.

The reference numeral 7 denotes a voltage at zero volts, for example, which is present on an electromagnet of a clutch with the armature plate in its disengaged state.

At an energizing point 9 the electromagnet of the clutch is subjected to a supply voltage, which in conventional clutches is equal to the available electrical system voltage 8 of the vehicle.

In FIG. 1, after engagement of the clutch the supply voltage of the electromagnet in a known manner is kept constant at the available electrical system voltage 8 of the vehicle (e.g. 24 volts) over the entire time curve, in order to provide a sufficient magnetic force for continuous operation.

When the supply voltage is shut off, the magnetic forces for the electromagnet are cancelled and the armature plate separates from the rotor, and at a supply voltage of 0 volts, for example, is disengaged from the latter.

FIG. 2 shows an inventive voltage profile 2 of an electromagnetically operated friction clutch, the supply voltage for the electromagnet starting from a voltage 7 (0 volts).

At the energizing point 9 the electromagnet is subjected to a supply voltage, which briefly is approximately equal to the available electrical system voltage 8 of the vehicle.

The transient increase in the supply voltage for the electromagnet may lie in the range between an operating voltage level 3 and the available electrical system voltage 8 of the vehicle and is held for a requisite period of time in order to generate a magnetic force sufficient to attract the armature plate towards the rotor.

Subsequent timing, for example by pulse width modulation, serves to reduce the supply voltage to the operating voltage level 3, the timing taking place within a constant cycle duration 6.

After engagement of the clutch the supply voltage of the electromagnet can be reduced to an operating voltage level 3, for which the electromagnet is designed for an operating phase with a continuously engaged clutch.

The control means are designed to predefine a pulse width, which forms a mean supply voltage for a continuous operating phase of a clutch.

A mean supply voltage may be set, which lies at an operating voltage level 3, which just prevents disengagement of the clutch and can therefore be referred to as an ‘optimized’ operating voltage level.

In the event of voltage fluctuations in the electrical system voltage 8, the control means can readjust the pulse width according to the fluctuations, in order to prevent a premature disengagement of the clutch.

### LIST OF REFERENCE NUMERALS

1 voltage profile for a known electromagnetically operated friction clutch

2 voltage profile for an electromagnetically operated friction clutch with pulse width modulated voltage supply

3 operating voltage level

4 time axis

5 voltage axis

6 cycle duration

7 voltage (0 volts)

8 electrical system voltage (e.g. 24 volts)

9 energizing point

We claim:

1. An electromagnetically operated clutch, in particular a friction clutch, for switching on and off units, such as a water pump, for example, in a vehicle, in particular a motor vehicle, comprising:
a predefined electrical system voltage;
a clutch comprising an electromagnet with at least one coil, a rotor, and an armature plate, which is drawn against the rotor by the forces of the electromagnet in order to engage the clutch; and
control means, wherein the control means, in respect of a continuous operating state, are designed for an operating voltage level, which is less than the available electrical system voltage of the vehicle, the control means being suited to switching the electromagnet with a voltage level for engagement of the friction clutch that is greater than the operating voltage level and, by timing a supply voltage, to reducing it to the design operating voltage level for an operating phase when the clutch is continuously engaged.

2. The electromagnetic clutch as claimed in claim 1, wherein the supply voltage of the electromagnet at the energizing point is equal to the available electrical system voltage of the vehicle.

3. The electromagnetic clutch as claimed in claim 1, wherein the supply voltage can be timed by means of pulse width modulation (PWM).

4. The electromagnetic clutch as claimed in claim 1, wherein the control means reduce the voltage to an operating voltage level in the order of half the electrical system voltage of the vehicle.

5. The electromagnetic clutch as claimed in claim 1, wherein the control means reduce the voltage to an operating voltage level by means of a pulse width modulation (PWM) signal with predefined cycle duration.

6. The electromagnetic clutch as claimed in claim 1, wherein the control means are designed to readjust a pulse width of the PWM signal as a function of the prevailing vehicle electrical system voltage.

7. The electromagnetic clutch as claimed in claim 1, wherein the control means are suited to predefining a pulse width for a varying electrical system voltage, which is required for a continuous operating phase of the clutch.

8. The electromagnetic clutch as claimed in claim 1, wherein the control means are embodied as a retrofitted unit.

9. A method of operating an electromagnetic clutch as claimed in claim 1, wherein the control means, by means of timing, reduce the supply voltage for the electromagnet to an operating voltage level for an operating phase with a continuously engaged clutch, the operating voltage level being less than the available electrical system voltage of a motor vehicle.
